(19) United States
(12) Patent Application Publication
(10) Pub. No.: US 2006/0254616 A1
(43) Pub. Date: Nov. 16, 2006

(54) Temperature control of a substrate during wet processes

(76) Inventors: Brian Brown, Palo Alto, CA (US); Dennis Yost, Los Gatos, CA (US); James S. Papanu, San Rafael, CA (US); Jianshe Tang, San Jose, CA (US); Alexander Sou-Kang Ko, Santa Clara, CA (US)

Correspondence Address: APPLIED MATERIALS/BLAKELY, PATENT COUNSEL, LEGAL AFFAIRS DEPARTMENT, P. O. BOX 450A, SANTA CLARA, CA, 95054, US

(21) Appl. No.: 11/126,417

(22) Filed: May 11, 2005

(51) Int. Cl. C23G 1/00; B08B 3/00

(52) U.S. Cl. 134/2; 134/26; 134/28; 134/34; 134/94.1

(57) ABSTRACT

Embodiments of the invention provide methods of applying a liquid to a backside of a substrate to bring the substrate to the temperature of the liquid. By controlling the temperature of the substrate the temperature of the semiconductor processing liquid may be maintained at a particular temperature or a type of reaction occurring in the semiconductor processing liquid may be enhanced or maintained, such as in reactions where relatively small amounts of liquid are used or expensive chemicals are used.

### BACKGROUND OF THE INVENTION

1. Field of the Invention

The present invention relates to the field of semiconductor substrate surface cleaning.

2. Discussion of Related Art

Integrated circuits are formed on semiconductor wafers. The wafers are then sawed (or “singulated” or “diced”) into microelectronic dice, also known as semiconductor chips, with each chip carrying a respective integrated circuit. Each semiconductor chip is then mounted to a package, or carrier, substrate. Often the packages are then mounted to a motherboard, which may then be installed into a computing system.

Numerous steps may be involved in the creation of the integrated circuits, such as the formation and etching of various semiconductor, insulator, and conductive layers. During the manufacturing of the integrated circuits, the surface of the wafer may also have to be cleaned at various times before the formation of the integrated circuits can be completed. One common method for cleaning the wafers is referred to as “spin cleaning.”

Spin cleaning involves dispensing a cleaning solution onto the wafer and spinning the wafer to remove the solution. Typically, in order to effectively clean the wafer, the wafer must undergo several spin clean “passes.”

On each pass a relatively large amount of the solution, sometimes over 300 milliliters, is dispensed onto the wafer as it spins. The solutions used to clean the wafers are sometimes very expensive, particularly those used to clean copper and low-k dielectric surfaces. Thus, manufacturers often recycle, or re-circulate, the cleaning solution from each pass so that it may be reused on a subsequent pass.

Additionally, most single wafer spin cleaners employ chucks that either purge the backside with gas or hold the wafer against the chuck with a vacuum. To increase or decrease the temperature of the reaction at the front side surface of the wafer, one needs to heat or cool the frontside liquid. This approach has several disadvantages. In order to adequately heat the wafer, one needs to run very high liquid flows. This can add to the cost of the process. If the chemicals are expensive, this requires employing methods to capture the liquid, for reclamation and reuse. This adds significant cost and complexity to the system itself, and is not always viable for unstable chemicals.

Also, some chemicals used in cleaning and etching are unstable at high temperatures so heating the liquid by conventional means, e.g. recirculated heaters, mixing with hot water, etc., can have detrimental effects due to the long residence time at high temperatures.

Furthermore, to achieve good temperature uniformity across a wafer, the wafer must be spun at high speeds and the flow rate increased to reduce center to edge cooling or heating. This leads to high chemical consumption and potential for splashing of liquid within the chamber which can result in particle or residue defects on the wafers after processing.

### SUMMARY OF EMBODIMENTS OF THE INVENTION

Embodiments of the invention include providing a semiconductor substrate at a first temperature in a single substrate cleaning tool, applying a first semiconductor substrate processing liquid at a second temperature to the lower surface of the semiconductor substrate to bring the semiconductor substrate to the second temperature, and applying a second semiconductor substrate processing liquid to the upper surface of the semiconductor substrate. The first semiconductor substrate processing liquid may be applied to the lower surface of the semiconductor substrate before applying the second semiconductor substrate processing liquid to the upper surface for a time sufficient to bring the semiconductor substrate to the second temperature. The first semiconductor processing liquid may also be applied to the lower surface continuously while the second semiconductor processing liquid is applied to the upper surface.

In another embodiment deionized water having a temperature in an approximate range of 80° C. and 100° C. is applied to the lower surface of a semiconductor substrate to heat the semiconductor substrate and micro-droplets of less than 50 ml of a cleaning solution are sprayed onto an upper surface of the semiconductor substrate after heating the semiconductor substrate.

In yet another embodiment deionized water having a temperature in an approximate range of 80° C. and 100° C. is applied to the lower surface of a semiconductor substrate to heat the semiconductor substrate, a puddle of an exothermic cleaning solution is formed on an upper surface of the semiconductor substrate, and the puddle is allowed to stand on the upper surface of the semiconductor substrate for a time sufficient to clean the semiconductor substrate.

### BRIEF DESCRIPTION OF THE DRAWINGS

FIG. 1 is a cross-sectional schematic view of a semiconductor substrate processing apparatus, including a substrate support assembly and a dispense assembly;

FIG. 2 is a cross sectional side view of the substrate support assembly; FIG. 3A is a cross-sectional schematic view of the semiconductor substrate processing apparatus similar to FIG. 1;

FIG. 3B is a cross-sectional schematic view of the semiconductor substrate processing apparatus in which the lower surface of the semiconductor substrate is coated with a liquid by centrifugal force;

FIG. 3C is a cross-sectional schematic view of the semiconductor substrate processing apparatus including a showerhead to spray a liquid on the lower surface of the semiconductor substrate;

FIGS. 3D and 3E are cross-sectional side views of the substrate support assembly and the dispense assembly illustrating operation of the semiconductor substrate processing apparatus;

### DETAILED DESCRIPTION OF THE PRESENT INVENTION

In the following description, various aspects of the present invention will be described, and various details will be set forth in order to provide a thorough understanding of a present invention. However, it will be apparent to those skilled in the art that the present invention may be practiced with only some or all of the aspects of the present invention, and the present invention may be practiced without the specific details. In other instances, well-known features are omitted or simplified in order not to obscure the present invention.

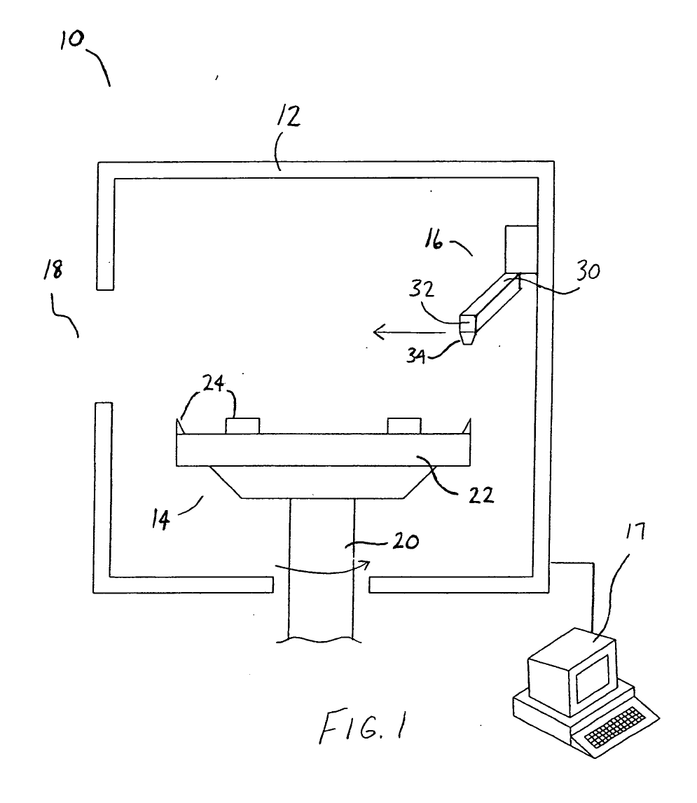

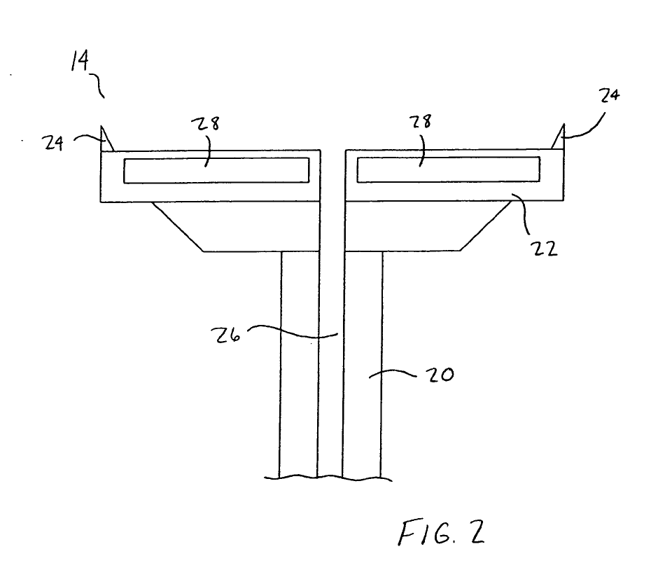

It should be understood that FIGS. 1-3E are merely illustrative and may not be drawn to scale.

Embodiments of the invention provide methods of applying a liquid to a lower surface of a semiconductor substrate within a single substrate cleaning tool to bring the semiconductor substrate to the temperature of the liquid. By controlling the temperature of the semiconductor substrate, the temperature of the semiconductor substrate processing liquid on the upper surface of the semiconductor substrate may be maintained at a particular temperature or a type of reaction occurring in the semiconductor processing liquid may be enhanced or maintained. Controlling the temperature of the semiconductor substrate processing liquid on the upper surface of the semiconductor substrate through the temperature of the semiconductor substrate may be valuable in processes where relatively small amounts of semiconductor substrate processing liquid are used on the upper surface of the semiconductor substrate, such as in a low volume dispense method or a method where a puddle of liquid is formed and allowed to stand. Temperature control of the semiconductor substrate processing liquid on the upper surface of the semiconductor substrate through the temperature of the semiconductor substrate may also be valuable in minimizing the amount of semiconductor processing liquids used, for example, in processes utilizing expensive chemicals.

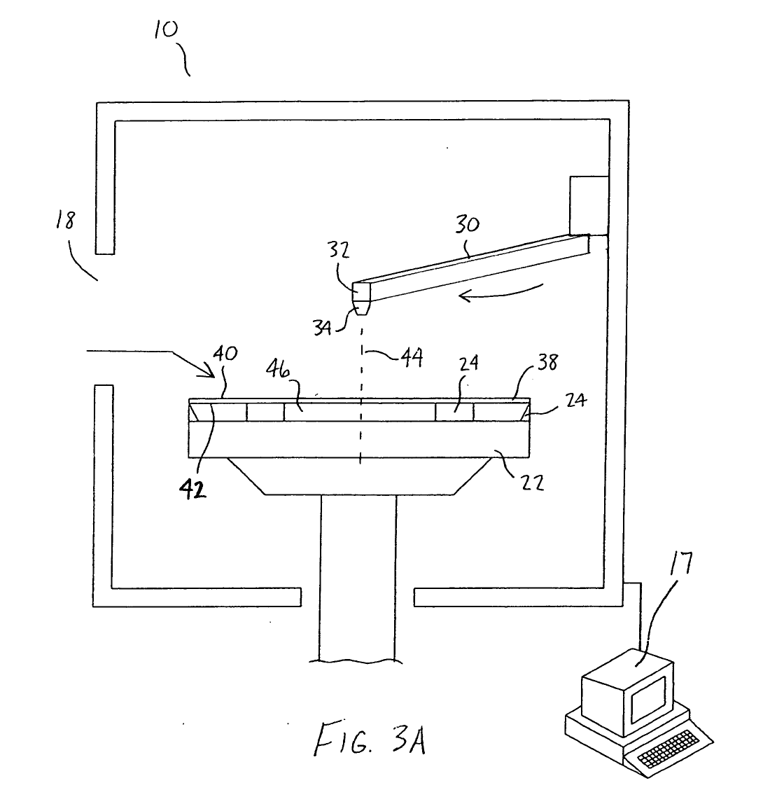

FIG. 1 to FIG. 3E illustrate a method and apparatus for cleaning a semiconductor substrate. FIGS. 1 and 2 illustrate a single substrate cleaning tool, or a spin clean chamber 10, according to one embodiment of the present invention. The spin clean chamber 10 may include a chamber wall 12, a substrate support assembly 14, a dispense assembly 16, and a computer control console 17. The chamber wall 12 may be, in cross-section, substantially square with a substrate slit 18, in one side thereof. The substrate support assembly 14 may lie within the chamber wall 12 at a lower portion thereof at a height lower than the substrate slit 18. The substrate support assembly 14 may include a substrate support axis 20 and a substrate support 22. The substrate support axis 20 may vertically extend through a lower piece of the chamber wall 12, and the substrate support 22 may be attached to an upper end of the substrate support axis 20. The substrate support axis 20 may be able to rotate the substrate support 22 about a central axis thereof at various rates between, for example, 1 revolution per minute (rpm) and 3000 rpm.

As illustrated in FIGS. 1 and 2, the substrate support 22 may include support members 24 which extend upwards from an outer edge of the substrate support 22 and piezoelectric transducers 28 which may be embedded on the backside of the substrate support 22 to form a megasonic plate. Alternatively, instead of a megasonic plate the substrate support 22 may be a baffle. A support liquid channel 26 may run vertically through a central portion of the substrate support 22 and the substrate support axis 20.

Although not illustrated in detail, it should be understood that the support liquid channel 26 may be connected to supplies of various semiconductor substrate processing liquids. These liquid supplies may be at the point of use or may be off-site. The supplies to the liquid channel 26 may come from a heater that heats the liquid, such as a resistive heater, or from a refrigerator that cools the liquid.

Referring again to FIG. 1, the dispense assembly 16 may be attached to an upper portion of a sidepiece of the chamber wall 12 opposite the substrate slit 18. The dispense assembly 16 may include a dispense arm 30 and a dispense head 32. The dispense arm 30 may be rotatably connected to the chamber wall 12 to move the dispense head 32 back and forth between a position where the dispense head 32 is not positioned over the substrate support 22 and a position where the dispense head 32 is suspended over the substrate support 22. The dispense head 32 may be attached to an end of the dispense arm 30 and may include a nozzle 34. The dispense arm 30 may be moved to a fixed position during processing steps and/or swept continuously across the substrate. In one embodiment, the nozzle may sweep along a path between a center region of the substrate and a first edge region of the substrate, where the nozzle has a first velocity near the center region and a second velocity near the first edge region that is slower relative to the first velocity to provide a uniform contact time of the substrate processing fluid with the top surface of the substrate. The semiconductor processing fluid may be dispensed from the nozzle along a sweep path between a center region and a first edge region of the substrate. The nozzle has a first velocity near the center region and a second velocity near the first edge region that is slower relative to the first velocity to provide a uniform contact time of the semiconductor processing fluid with the top surface of the wafer. The application of the semiconductor processing fluid to the substrate is more uniform because the slower velocity near the edge of the wafer results in lower centrifugal force near the wafer edge so that the fluid remains in contact with the substrate surface longer relative to the substrate center where the sweep velocity is higher. Thus, all areas of the substrate surface receive substantially the same exposure time to the fluid. The sweep profile may approximate a sinusoidal pattern. Although not illustrated in detail, it should be understood that the first nozzle 34 may also be connected to supplies of various semiconductor substrate processing liquids through fluid channels that run through the dispense arm 30.

The computer control console 17 may be in the form of a computer having memory for storing a set of instructions and a processor connected to the memory for executing the instructions, as is commonly understood in the art. The instructions stored within the memory may include a method including spraying a relatively low amount of solution onto a substrate on the substrate support 22, rotating the substrate support 22 at a relatively low rate, allowing the solution to stand on the substrate before being rinsed off the substrate, and applying a liquid at a first temperature to the backside substrate as described below. The computer control console 17 may be electrically connected to both the substrate support assembly 14 and the dispense assembly 16, as well as all of the various components thereof, and may be used to control and coordinate the various operations of the spin clean chamber 10.

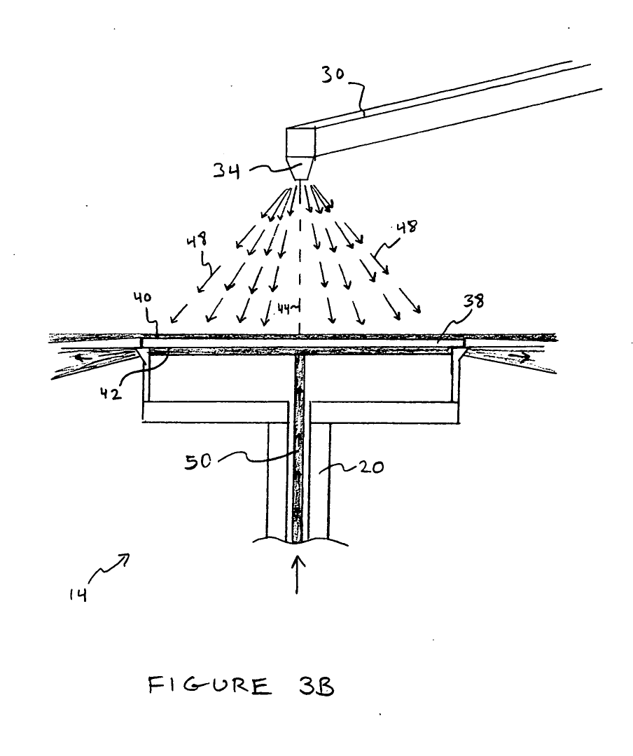

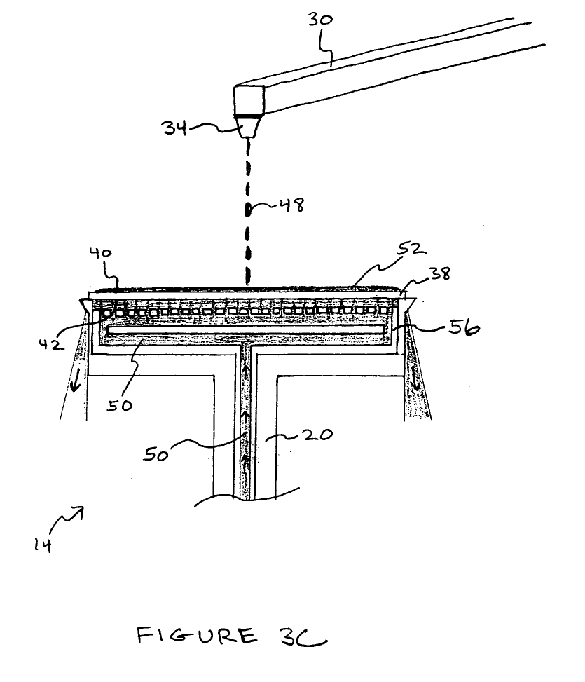

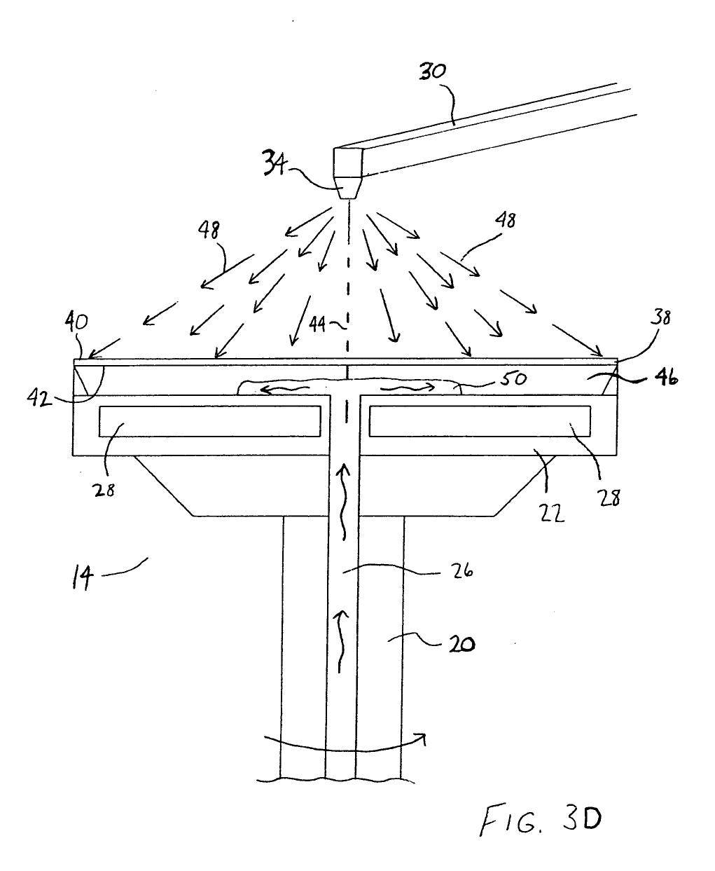

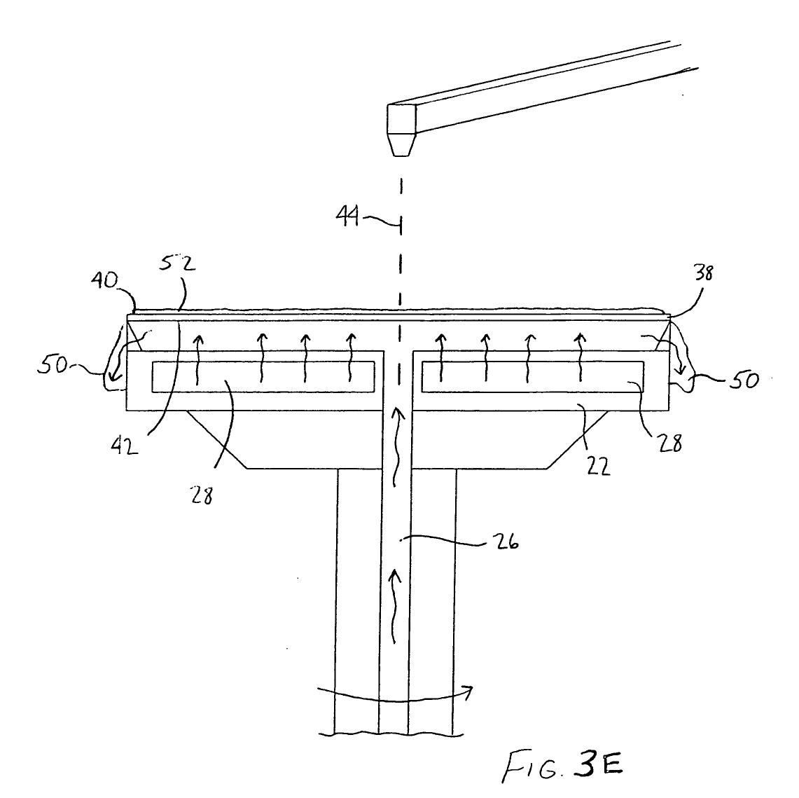

In use, referring to FIG. 3A, a semiconductor substrate 38, such as a semiconductor wafer with a diameter of, for example, 200 or 300 millimeters, may be transported through the substrate slit 18, over the substrate support 22, and directly onto the support members 24. The semiconductor substrate 38 may have an upper surface 40 (or a “device” surface), a lower surface 42 (or a “back-side” or “non-device” surface), and a central axis 44. The semiconductor substrate 38 has a first temperature. This temperature may be approximately room temperature (27° C.). The upper surface 40 of the semiconductor substrate 38 may have, for example, post-metallization (back end of the line), portions of exposed copper or low-k dielectric, such as carbon-doped oxide, a hydrogen or oxygen-doped silicon oxide, or an organic based low-k dielectric. The lower surface 42 of the semiconductor substrate 38 may have, for example, portions of exposed silicon such as monocrystalline silicon.

Although not illustrated in detail, the semiconductor substrate 38 may be “wedged” between the support members 24 so that the central axis 44 is positioned over a central portion of the substrate support 22, and the support members 24 may prevent the semiconductor substrate 38 from moving laterally between edges of the substrate support 22. As illustrated in FIG. 3B, a gap 46 may lie between the lower surface 42 of the semiconductor substrate 38 and the substrate support 22.

Referring again to FIG. 3A, after the semiconductor substrate 38 has been placed on the substrate support 22, the dispense arm 30 may rotate such that the dispense head 32 is suspended over the semiconductor substrate 38 in a first position. In particular, the dispense head 32 may be suspended above the semiconductor substrate 38 such that the nozzle 34 is positioned directly over the primary axis 44 of the semiconductor substrate 38.

After providing the semiconductor substrate at a first temperature, a first semiconductor substrate processing liquid at a second temperature may be applied to the lower surface 42 of the semiconductor substrate 38 for a time sufficient and at a volume flow sufficient to bring the semiconductor substrate 38 to the second temperature. The volume flow of the first semiconductor substrate processing liquid that is applied to the lower surface 42 may be higher than the volume flow of the second semiconductor substrate 38 processing liquid applied to the upper surface 40. The second temperature of the first semiconductor substrate processing liquid may be in a hot or a cold temperature range depending on the semiconductor substrate processing liquid applied to the upper surface of the semiconductor substrate should be maintained at a hot or cold temperature. In one embodiment the second temperature may be in a hot range at a temperature in the approximate range of 40° C. and 100° C., or more particularly in the approximate range of 80° C. and 100° C. In another embodiment the second temperature may be in a cold range at a temperature in the approximate range of 5° C. and 20° C. and more particularly in the approximate range of 15° C. and 20° C.

In one embodiment the first semiconductor substrate processing liquid 50 may be injected into the gap 46 beneath the semiconductor substrate 38 through the support liquid channel 26. The vertical thickness of the gap 46 may be in the approximate range of 2 mm and 5 mm, and more particularly approximately 3 mm. The vertical thickness of the gap 46 is thin so that smaller volumes of the first semiconductor substrate processing liquid 50 that is passed through the gap 46 to heat or cool the semiconductor substrate 38 may be used to save costs. In another embodiment, as illustrated in FIG. 3B, the first semiconductor substrate processing liquid 50 may be applied to the lower surface 42 of the semiconductor substrate 38 by flowing a stream of the first semiconductor processing liquid 50 in the center of the lower surface of the semiconductor substrate while spinning the semiconductor substrate at a spin rate sufficient to coat the lower surface 42 of the semiconductor substrate 38 with the liquid by centrifugal force. In this embodiment, the spin rate of the semiconductor substrate 38 that is a 300 mm wafer may be greater than approximately 200 rpm. In another embodiment, as illustrated in FIG. 3C, the first semiconductor substrate processing liquid 50 may be applied to the lower surface 42 of the semiconductor substrate 38 as a spray from a shower-head 56. The first semiconductor substrate processing liquid 50 may be deionized water (DI water) or a cleaning solution such as a mixture of ammonium hydroxide (NH₄OH) and hydrogen peroxide (H₂O₂).

As illustrated in FIG. 3D, the substrate support axis 20 may then rotate the substrate support 22 about the central axis 44. The substrate support 22, and thus the semiconductor substrate 38, may be rotated at a first, relatively low rate, such as less than 100 rpm or less than 50 rpm. In one embodiment, the first rate may be less than 30 rpm, such as 15 rpm.

After the rotation of the substrate support 22 has begun at a low rate, a second semiconductor substrate processing liquid 48 may be sprayed from the nozzle 34 onto the upper surface 40 of the semiconductor substrate 38 once the semiconductor substrate 38 has reached the target temperature. The second semiconductor substrate processing liquid 48 may be suitable to clean the portions of the upper surface 40 of the semiconductor substrate 38 with the exposed copper or low-k dielectric, such as ST-250 manufactured by ATMI, ACT NE-14 manufactured by Air Products, or LK-1 manufactured by Kanto, or other suitable cleaning solutions. The second semiconductor substrate processing liquid 48 may be dispensed from the nozzle along a sweep pateh between a center region and a first edge region of the substrate. The nozzle has a first velocity near the center region and a second velocity near the first edge region that is slower relative to the first velocity to provide a uniform contact time of the wafer processing fluid with the top surface of the wafer. The application of the second semiconductor substrate processing liquid 48 to the substrate is more uniform because the slower velocity near the edge of the wafer results in lower centrifugal force near the wafer edge so that the fluid remains in contact with the wafer surface longer relative to the wafer center where the sweep velocity is higher. Thus, all areas of the substrate surface receive substantially the same exposure time to the fluid. The sweep profile may approximate a sinusoidal pattern.

The first semiconductor substrate processing liquid at the second temperature may be applied to the lower surface 42 of the semiconductor substrate 38 continuously while applying the first semiconductor substrate processing liquid to the upper surface 40 of the substrate. The first semiconductor substrate processing liquid may be applied to the lower surface 42 of the semiconductor substrate 38 at a flow rate sufficient to maintain the semiconductor substrate 38 at the target temperature and to maintain temperature uniformity across the semiconductor substrate 38. The flow rate of the first semiconductor substrate processing liquid applied to the lower surface 42 of the semiconductor substrate 38 may need to be relatively higher than the flow rate of the second semiconductor substrate processing liquid applied to the upper surface 40 of the semiconductor substrate 38 in embodiments where the spin rate of the semiconductor substrate 38 is low to maintain temperature uniformity across the semiconductor substrate 38. By controlling the temperature of the semiconductor substrate 38 in this way the temperature of the semiconductor substrate processing liquid 48 may also be controlled.

As the second semiconductor substrate processing liquid 48 leaves the nozzle 34, the liquid 48 may be in the form of micro-droplets that are sprayed substantially over the entire upper surface 40 of the semiconductor substrate 38 in a substantially even fashion. Micro-droplets are an extremely fine mist of liquid. The micro-droplets may be sprayed from a high velocity spray jet that would serve as the nozzle 34. The second semiconductor substrate processing liquid 48 may be a fresh solvent that is applied once to the semiconductor substrate 38 and then disposed of, such that the fresh solvent is used in only a single pass. The rotation of the semiconductor substrate 38 about the central axis 44 may further increase the evenness of the distribution of the first semiconductor substrate processing liquid 48. The second semiconductor processing liquid 48 may be sprayed for a relatively short amount of time, such as between approximately 3 and 5 seconds. The amount of the second semiconductor substrate processing liquid 48 that is sprayed as micro-droplets onto the upper surface 40 of the semiconductor substrate 38 may be relatively small, such as less than 100 milliliters (ml), in particular less than 30 ml. In one embodiment of this low volume dispense method, the semiconductor substrate 38 may be a wafer having a diameter of approximately 300 mm and the total amount of the second semiconductor processing liquid 48 dispensed as micro-droplets on the upper surface 40 may be approximately 20 ml. The temperature of the semiconductor substrate 38 may be changed to the second semiconductor substrate processing liquid 48 due to the comparatively large surface area and bulk volume of the semiconductor substrate 38 compared to the small volume of the second semiconductor substrate processing liquid 48. Therefore, by controlling the temperature of the semiconductor substrate 38 the temperature of the second semiconductor substrate processing liquid 48 applied to the upper surface 40 of the semiconductor substrate 38 may be controlled as well. Temperature uniformity of the second semiconductor substrate processing liquid 48 may also be achieved across the upper surface 42 of the semiconductor substrate 38, particularly when a low volume of the second semiconductor substrate processing liquid 48 is utilized. The low volume dispense of the second semiconductor substrate processing liquid 48 is valuable when only a single pass of the liquid is used because it makes it economical to dispose of the liquid after only a single use.

In an embodiment of a low volume dispense method, the second semiconductor substrate processing liquid 48 may be a cleaning solution including ammonium hydroxide (NH₄OH), hydrogen peroxide (H₂O₂), and deionized water (DI-H₂O). The cleaning solution may also include surfactants and/or chelating agents. Because a low volume of the second semiconductor substrate processing liquid is utilized, the temperature of the reactions that occur within the second semiconductor substrate processing liquid are dominated by the temperature of the semiconductor substrate 38. In this embodiment, the semiconductor substrate 38 is pre-heated to a temperature in the approximate range of 80° C. and 100° C. by applying hot DI-water within the same temperature range to the lower surface 42 of the semiconductor substrate 38 prior to applying the cleaning solution to the upper surface 40. The hot DI-water may be applied by filling the gap 46 with hot DI-water, the gap 46 having a vertical thickness of approximately 3 mm. The flow rate of the DI-water during the pre-heat may be in the approximate range of 300 ml/min and 1500 ml/min while spinning the semiconductor substrate in the approximate range of 2 rpm and 500 rpm. The time of the pre-heat may be in the approximate range of 5 seconds and 30 seconds. The cleaning solution is then applied to the upper surface 40 of the semiconductor substrate 38 in the form of micro-droplets that are sprayed substantially over the entire upper surface 40 of the semiconductor substrate 38 in a substantially even fashion. The cleaning solution may be sprayed for a relatively short amount of time, such as between approximately 3 and 5 seconds. The amount of the cleaning solution that is sprayed onto the upper surface 40 of the semiconductor substrate 38 may be in the range of 20 ml and 30 ml. The hot DI-water is continuously applied to the lower surface 42 of the semiconductor substrate 38 during the application of the cleaning solution to the upper surface 40 of the semiconductor substrate 38 to maintain the temperature of the semiconductor substrate 38. The flow rate of the hot DI-water is sufficient to maintain the semiconductor substrate 38 within the temperature range of 80° C. and 100° C. and to maintain temperature uniformity across the semiconductor substrate 38. In an embodiment the flow rate may be in the approximate range of 600 ml/min and 1200 ml/min while spinning the semiconductor substrate 38 at a spin rate in the approximate range of 5 rpm and 200 rpm while the hot DI-water is continuously applied. The temperature of the cleaning solution may thereby be maintained at a high temperature to promote the etching of particles from the surface of the semiconductor substrate 38. The etching of particles on the surface leads to better particle removal efficiency in tandem to removing particles by momentum transfer due to the spinning of the wafer. This in turn leads to fewer particle defects. The transducers 28 may be activated to send mega sonic energy through the DI-water within the gap 46 to further assist in the cleaning of the upper surface 40. Additionally, because more effective cleaning can be accomplished with less cleaning solution, costs can be saved by reducing consumption of expensive chemicals, particularly if chelating agents or surfactants are used in the cleaning solution. After applying the second semiconductor processing liquid 48 to the upper surface 42 of the semiconductor substrate 38 for a time sufficient to clean the upper surface 42, the upper surface 42 is rinsed with a DI-water rinse to remove the second semiconductor substrate processing liquid 48. After spinning off the liquid from the upper surface 42 of the semiconductor substrate 38, the second semiconductor substrate processing liquid 48 is disposed of along with the rinse.

In another embodiment, as illustrated in FIG. 3E, after the second semiconductor substrate processing liquid 48 has been dispensed onto the semiconductor wafer 38, a puddle 52 of the second semiconductor substrate processing liquid 48 may stand on the upper surface 40 of the semiconductor substrate 38. The puddle 52 may have, for example, a thickness of between approximately 100 and 200 microns. As illustrated in FIG. 3E, the puddle 52 may cover substantially all of the upper surface 40 of the semiconductor substrate 38. Because of the relatively small amount of liquid 48 (less than approximately 100 ml) dispensed onto the upper surface 40 of the semiconductor substrate 38, as well as the relatively low rate of rotation of the semiconductor substrate 38 (less than approximately 50 rpm), along with the surface tension of the liquid within the puddle 52, all, or substantially all, of the liquid 48 within the puddle 52 remains on and cleans the upper surface 40 of the semiconductor substrate 38. In other words, substantially none of the liquid within the puddle 52 flows off the substrate 38. Utilizing a puddle 52 may be valuable in embodiments where expensive cleaning chemicals are used to minimize the amount of those chemicals that are consumed. The first semiconductor substrate processing liquid at the second temperature may be applied to the lower surface 42 of the semiconductor substrate 38 continuously while the puddle 52 remains on and cleans the upper surface 40 of the semiconductor substrate 38. The flow rate of the first liquid may be sufficient to maintain the target temperature and the temperature uniformity of the semiconductor substrate 38. By controlling the temperature of the semiconductor substrate 38 in this way the temperature of the second semiconductor substrate processing liquid 48 within the puddle 52 may also be controlled.

Still referring to FIG. 3E, the puddle 52 may be allowed to stand on the upper surface 40 of the semiconductor substrate 38 for an extended period of time. The puddle 52 may be allowed to stand on the upper surface 40 of the semiconductor substrate 38 for a time sufficient to clean the semiconductor substrate. In one embodiment, the puddle 52 may be allowed to stand on, and clean, the upper surface 40 of the semiconductor substrate 38 for over 10 seconds, or even 30 seconds. The substrate support axis 20 may continue to rotate the substrate support 22 at the first rate for the entire time that the puddle 52 remains standing on the upper surface 40 of the semiconductor substrate 38. The spin rate of the semiconductor substrate 38 may be in the approximate range of 1 rpm and 10 rpm while the puddle 52 stands. The temperature of the semiconductor substrate 38 may be controlled during the time that the puddle 52 is allowed to stand on the upper surface 40 of the semiconductor substrate by applying the first semiconductor substrate processing liquid at a particular temperature to the lower surface 42 of the semiconductor substrate 38. To maintain the temperature of the liquid in the puddle 52 may be maintained at a constant and uniform temperature during substantially the entire time that the puddle 52 is allowed to stand on the upper surface 40 the flow rate of the first semiconductor processing liquid may be in the approximate range of 600 ml/min and 1200 ml/min. By maintaining a constant temperature of the second semiconductor substrate processing liquid in the puddle the effectiveness of the second semiconductor substrate processing liquid may also be maintained or even enhanced. For example, the effectiveness of a second semiconductor substrate processing fluid that acts on the surface of the semiconductor substrate 38 through an exothermic reaction may be increased or maintained for a longer period of time by maintaining the second semiconductor substrate processing fluid at a high temperature close to that of the exothermic reaction. The residue removal speed may also be increased in this way. The increased effectiveness and residue removal speed of the cleaning solution may lead to less consumption of the cleaning solution.

In an embodiment, the second semiconductor processing liquid within the puddle may be a sulfuric peroxide mixture (SPM). An SPM solution may be used, for example, to remove photoresist residues and ashing residues after ashing a photoresist on the upper surface 40 of the semiconductor substrate 38 or to remove unreacted nickel after a nickel salicide strip. The SPM solution may be used during front end of the line processing. Front end of the line describes the semiconductor substrate pre-metallization. In an embodiment, the SPM is a mixture of 98% sulfuric acid (H₂SO₄) and 30% hydrogen peroxide (H₂O₂). The sulfuric peroxide mixture is typically mixed at the point of use because the mixing of the sulfuric acid and the hydrogen peroxide causes an exothermic reaction that may have temperatures of up to approximately 120° C. if the sulfuric acid is added to the hydrogen peroxide at room temperature or approximately 150° C. if the sulfuric acid added to the mixture is 80° C. In this embodiment DI-water at a temperature in the approximate range of 80° C. and 100° C. may be applied to the backside of the semiconductor substrate for a time in the approximate range of 5 seconds and 30 seconds and more particularly approximately 10 seconds to pre-heat the semiconductor substrate 38 before dispensing the SPM mixture onto the upper surface 40 of the semiconductor substrate 38. The spin rate of the semiconductor substrate 38 during the pre-heat may be in the approximate range of 5 rpm and 500 rpm and the flow rate of the hot DI-water may be in the approximate range of 500 ml/min and 2000 ml/min. Less than approximately 50 ml of the SPM solution is then dispensed onto the upper surface 40 of the semiconductor substrate 38 to form a puddle 52 having a thickness of between approximately 100 and 200 microns in an embodiment where the semiconductor substrate 38 is a 300 mm wafer. As illustrated in FIG. 3C, the puddle 52 may cover substantially all of the upper surface 40 of the semiconductor substrate 38. The semiconductor substrate 38 may spin at less than approximately 50 rpm to spread out the puddle. The hot DI-water is continuously applied to the backside of the semiconductor substrate 38 while the SPM mixture is dispensed onto to the upper surface 40 of the semiconductor substrate 38 and during the time period when a puddle 52 of the SPM solution stands on the upper surface 40 of the semiconductor substrate 38. The flow rate of the DI water may be in the approximate range of 500 ml/min and 2000 ml/min to maintain temperature uniformity. The puddle 52 containing the SPM solution may stand on the upper surface 40 of the semiconductor substrate 38 for a time in the approximate range of 10 s and 300 s. The spin rate of the semiconductor substrate while the puddle stand may be less than approximately 50 rpm. Mega sonic energy may be applied to the lower surface 42 of the semiconductor substrate 38 through the DI-water filled gap during the time the puddle 52 stands on the upper surface 40. The exothermic reaction of the SPM solution may be prolonged and enhanced by maintaining the semiconductor substrate 38 at a high temperature in the range of 80° C. and 100° C. Additionally, the improved effectiveness of the reaction means that less of the expensive concentrated chemicals in the SPM solution may be used and therefore costs may be lowered as well.

We claim:

1. A method, comprising:
providing a semiconductor substrate at a first temperature in a single substrate cleaning tool;
applying a first semiconductor substrate processing liquid at a second temperature to a lower surface of the semiconductor substrate to bring the semiconductor substrate to the second temperature; and
applying a second semiconductor substrate processing liquid to an upper surface of the semiconductor substrate.

2. The method of claim 1, wherein applying the first semiconductor processing liquid at the second temperature to the lower surface of the semiconductor substrate comprises:
applying the first semiconductor processing liquid at the second temperature to the lower surface of the semiconductor substrate before applying the second semiconductor substrate processing to the upper surface of the semiconductor substrate for a time sufficient to bring the semiconductor substrate to the second temperature; and
applying the first semiconductor processing liquid at the second temperature to the lower surface of the semiconductor substrate continuously while applying the second semiconductor substrate processing to the upper surface of the semiconductor substrate.

3. The method of claim 1, wherein applying the first semiconductor processing liquid at the second temperature to the backside of the semiconductor substrate comprises applying the first semiconductor processing liquid at a temperature in the approximate range of 40° C. and 100° C.

4. The method of claim 1, wherein applying the first semiconductor processing liquid at the second temperature to the lower surface of the semiconductor substrate comprises applying deionized water to the lower surface of the substrate.

5. The method of claim 1, wherein applying the second semiconductor processing liquid to the upper surface of the semiconductor substrate comprises applying an exothermic cleaning solution to the upper surface of the semiconductor substrate.

6. The method of claim 5, wherein applying the exothermic cleaning solution to the upper surface of the semiconductor substrate comprises applying a mixture of sulfuric acid and hydrogen peroxide.

7. The method of claim 1, wherein applying the second semiconductor processing liquid to the upper surface of the semiconductor substrate comprises applying less than 50 ml to the upper surface a 300 mm diameter wafer.

8. The method of claim 1, wherein applying the second semiconductor processing liquid solution to the upper surface of the semiconductor substrate comprises spraying a low volume of the second semiconductor processing liquid onto the topside of the semiconductor substrate.

9. The method of claim 1, wherein applying the second semiconductor processing liquid to the topside of the semiconductor substrate comprises forming a puddle on the upper surface of the semiconductor substrate and allowing the puddle to stand.

10. The method of claim 1, wherein applying the first semiconductor processing liquid at the second temperature to the backside of the semiconductor substrate comprises flowing a stream of the liquid in the center of the lower surface of the semiconductor substrate while spinning the semiconductor substrate at a spin rate sufficient to coat the lower surface of the semiconductor substrate with the liquid by centrifugal force.

11. The method of claim 1, wherein applying the first semiconductor processing liquid at the second temperature to the backside of the substrate comprises filling a space in between the backside of the semiconductor substrate and an acoustic energy plate.

12. The method of claim 1, wherein applying the first semiconductor processing liquid at the second temperature to the backside of the semiconductor substrate comprises spraying the first semiconductor processing liquid at the backside of the semiconductor substrate with a showerhead.

13. The method of claim 1, wherein applying the second semiconductor substrate processing liquid to the upper surface of the semiconductor substrate comprises dispensing the semiconductor substrate processing liquid from a nozzle and sweeping the nozzle along a sweep path between a center region and a first edge region of the semiconductor substrate, wherein the nozzle has a first velocity near the center region and a second velocity near the first edge region that is lower relative to the first velocity to provide a uniform contact time of the wafer processing fluid with the top surface of the semiconductor substrate.

14. A method, comprising:
applying deionized water having a temperature in an approximate range of 80° C. and 100° C. to the lower surface of a semiconductor substrate to heat the semiconductor substrate;
spraying micro-droplets of less than 50 ml of a cleaning solution onto an upper surface of the semiconductor substrate after heating the semiconductor substrate.

15. The method of claim 14, wherein spraying the cleaning solution onto the upper surface of the semiconductor substrate comprises spraying a solution comprising ammonium hydroxide (NH₄OH), hydrogen peroxide (H₂O₂), deionized water (DI-H₂O), and a chelating agent onto the upper surface of the semiconductor substrate.

16. The method of claim 14, further comprising applying deionized water having the temperature in the approximate range of 80° C. and 100° C. to the lower surface of the semiconductor substrate to heat the semiconductor substrate while spraying micro-droplets of less than 50 ml of the cleaning solution onto the upper surface of the semiconductor substrate after heating the semiconductor substrate.

17. The method of claim 14, further comprising applying mega sonics to the semiconductor substrate while spraying micro-droplets of less than 50 ml of the cleaning solution onto the upper surface of the semiconductor substrate after heating the semiconductor substrate.

18. The method of claim 14, wherein spraying micro-droplets of less than 50 ml of the cleaning solution onto the upper surface comprises spraying approximately 20 ml onto the upper surface

19. A method, comprising:
applying deionized water having a temperature in an approximate range of 80° C. and 100° C. to the lower surface of a semiconductor substrate to heat the semiconductor substrate;
forming a puddle of an exothermic cleaning solution on an upper surface of the semiconductor substrate; and
allowing the puddle to stand on the upper surface of the semiconductor substrate for a time sufficient to clean the semiconductor substrate while rotating the semiconductor substrate at a rate of less than approximately 50 rpm.

20. The method of claim 19, wherein applying deionized water having the temperature in the approximate range of 80° C. and 100° C. to the lower surface of the semiconductor substrate to heat the semiconductor substrate occurs before forming the puddle of the exothermic cleaning solution on the upper surface of the semiconductor substrate, while forming the puddle of the exothermic cleaning solution on the upper surface of the semiconductor substrate, and while allowing the puddle to stand on the upper surface of the semiconductor substrate for the time sufficient to clean the semiconductor substrate.

21. The method of claim 19, wherein the exothermic cleaning solution comprises hydrogen peroxide and sulfuric acid.

22. The method of claim 19, wherein applying deionized water having the temperature in the approximate range of 80° C. and 100° C. to the lower surface of the semiconductor substrate to heat the semiconductor substrate comprises applying the deionized water at a flow rate sufficient to maintain temperature uniformity across the semiconductor substrate.

23. A substrate processing system, comprising:
a single substrate cleaning tool;
a system controller for controlling the single substrate cleaning tool;
a machine-readable medium coupling to the controller, the machine-readable medium has a memory that stores a set of instructions that controls operations of the single substrate cleaning tool; and
wherein the set of instructions further controls all parameters of providing a semiconductor substrate at a first temperature within the single substrate cleaning tool, applying a first semiconductor substrate processing liquid at a second temperature to a lower surface of the semiconductor substrate to bring the semiconductor substrate to the second temperature, and applying a second semiconductor substrate processing liquid to an upper surface of the semiconductor substrate.
